(19) United States
(12) Patent Application Publication
(10) Pub. No.: US 2009/0074000 A1
(43) Pub. Date: Mar. 19, 2009

(54) Packet based switch with destination updating

(75) Inventors: Robert H. Bishop, Suwanee, GA (US); Angus David MacAdam, Suwanee, GA (US)

Correspondence Address: Roeder & Broder LLP, 5560 Chelsea Avenue, La Jolla, CA, 92037, US

(73) Assignee: Integrated Device Technology, Inc.

(21) Appl. No.: 11/901,418

(22) Filed: Sep. 17, 2007

(51) Int. Cl. H04L 12/56

(52) U.S. Cl. 370/419

(57) ABSTRACT

A switch (14) that transfers a packet (264) includes a plurality of ports (28) and a switch control system (63) that is electrically connected to the ports (28) and that controls the flow of data through the switch (14). The packet (264) includes a destination vector (215) having one or more original destinations (268). The switch control system (63) receives the destination vector (215) and allows the destination vector (215) to be dynamically updated. For example, the control system (63) can allow the destination vector to be dynamically updated during the transmission of the packet to the one or more original destinations (268). The control system (63) can allow one or more added destinations (268B) to be added to the destination vector (215) and/or the control system (63) can allow one or more of the original destinations (268) to be removed from the destination vector (215) with minimal, if any, influence on performance.

### BACKGROUND

Packet based switches are commonly used to transfer information between ports. The information can be transferred in relatively small units of data, commonly referred to as data packets. In a packet based switch, a destination vector of the data packet is provided to the packet switch at the beginning of the packet. The destination vector includes a single or a plurality of destination addresses that are used to route the data packet to the appropriate port(s). The destination vector remains static throughout transfer of the entire packet. For a unicast packet there is only one destination address present in the destination vector. Alternatively, for a multicast packet there are multiple destination addresses present in the destination vector.

### SUMMARY

The present invention is directed toward a switch that transfers a packet between ports of a switch. The packet includes a destination vector having a single or a plurality of original destinations. The switch includes a switch control system that is electrically connected to the ports. Further, the switch control system receives the destination vector and allows the destination vector to be dynamically updated while the packet is in the switch. In one embodiment, the control system allows the destination vector to be dynamically updated during the transmission of the packet to the single or many original destinations. This approach is both flexible and simple, and has minimal, if any, influence on the performance of the switch.

In one embodiment, the control system allows for one or more added destinations to be added to the destination vector while the packet is in the switch. Further, the control system can allow for one or more of the original destinations to be removed from the destination vector while the packet is in the switch.

Additionally, the switch can include a first port, a second port, and a third port. Further, the switch control system can include a destination register that stores the destination vector and a response register in which the destination vector is copied.

The present invention is also directed to a method for transferring a packet between ports. In one embodiment, the method includes the steps of electrically connecting a control system to the ports, and updating the destination vector in the control system while the packet is in the switch.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified illustration of one embodiment of a packet based switch having features of the present invention and a portion of an integrated circuit;

FIG. 2A is a simplified illustration of a portion of the integrated circuit of FIG. 1 illustrating a transmission of a data packet;

FIGS. 2B and 2C illustrate alternative possible destination vectors;

FIG. 3 is a simplified illustration of another embodiment of a packet based switch having features of the present invention and a portion of an integrated circuit; and

FIG. 4 is a flow chart that illustrates packet transfer flow in the switch of FIG. 1 or FIG. 3.

### DESCRIPTION

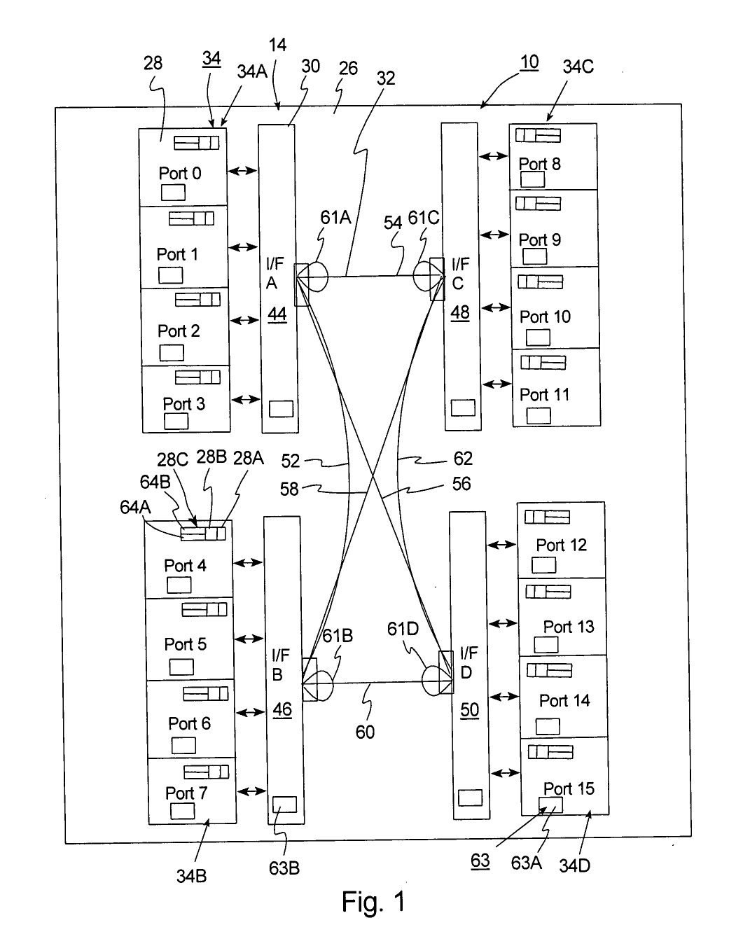

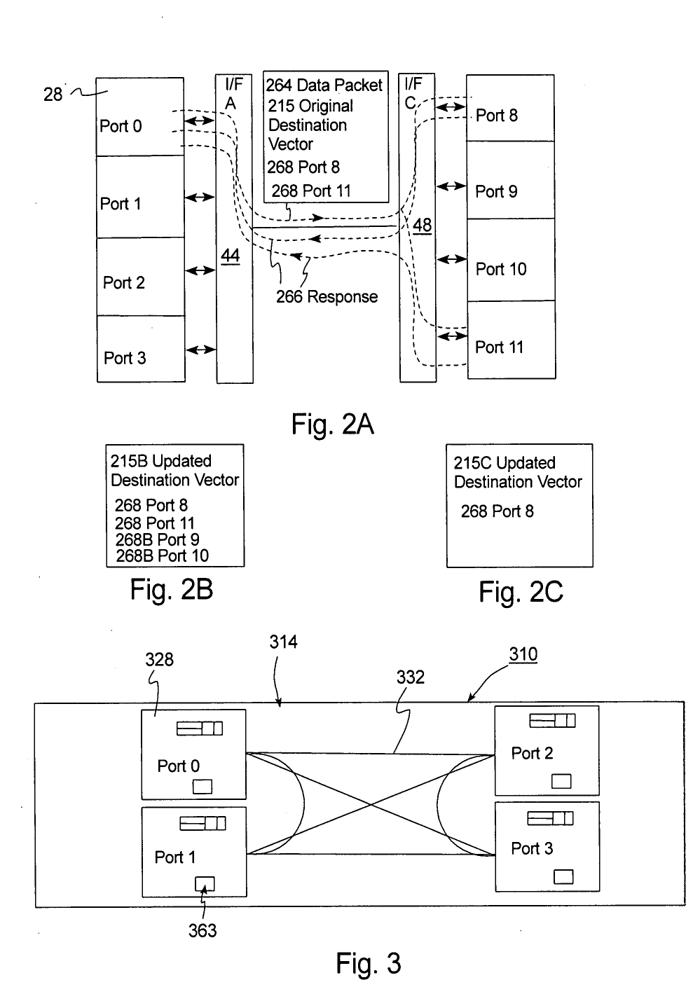

FIG. 1 is a simplified illustration of one, non-exclusive embodiment of a portion of an integrated circuit 10, and a data switch 14 having features of the present invention that is electrically connected to the integrated circuit 10. With this design, the data switch 14 is used to transfer data, e.g. data packets. As an overview, in certain embodiments, the switch 14 is uniquely designed to allow for the dynamic updating of a destination vector 215 (illustrated in FIG. 2A) during the transmission of data with minimal, if any adverse influence on the performance of the switch 14.

In one embodiment, the switch 14 includes a plurality of ports 28, a plurality of interfaces 30, and a plurality of electrical connectors 32. In this embodiment, the switch 14 takes advantage of the parallel nature of the mesh architecture while reducing the number of electrical connectors to reduce the overall size of the switch 14. In this embodiment, instead of using dedicated electrical connectors (not shown) from every port 28 to every other port 28, the present invention groups a number of ports 28 together into separate port groups 34. These port groups 34 are then connected with electrical connectors 32 in a mesh architecture, with every port group 34 being connected to every other port group 34.

In one embodiment, the integrated circuit 10 supports the components of the switch 14.

Each of the ports 28 provides a connector point for connecting to the integrated circuit 10. The number of ports 28 in the switch 14 can be changed to achieve the design requirements of the switch 14. In FIG. 1, the switch 14 includes sixteen ports 28 (labeled ports 0-15). Alternatively, the switch 14 can be designed with more than sixteen or fewer than sixteen ports 28. In FIG. 1, the ports 28 have been organized into four port groups 34, namely, an A port group 34A (including ports 0-3), a B port group 34B (including ports 4-7), a C port group 34C (including port 8-11), and a D port group 34D (including ports 12-15). Further, in FIG. 1, each of the port groups 34A-34D includes four ports 28. Alternatively, depending upon the design requirements of the switch 14, the ports 28 can be divided into more than four or fewer than four port groups 34A-34D, and/or one or more of the port groups 34A-34D can include more than four or fewer than four ports 28. It should be noted that any of these ports can be referred to as a first port, a second port, a third port, or a fourth port.

In one embodiment, each of the ports 28 includes (i) an output buffer 28A that provides temporary storage of data that is leaving the respective port 28; and (ii) an input buffer 28B that provides temporary storage of data arriving at the respective port. In one embodiment, there is a separate memory for each priority data packet. Alternatively, portions of a single memory can be used for each priority data packet.

Further, each port 28 can include a packet tracker 28C that tracks a certain number of packets. For example, the packet tracker 28C can track four packets per priority. Alternatively, the packet tracker 28C can be designed to track more than four or fewer than four packets per priority.

The number of interfaces 30 used in the switch 14 can be varied according to the number of port groups 34A-34D. In certain embodiments, each port group 34A-34D includes an interface 30. Thus, the number of interfaces 30 is equal to the number of port groups 34A-34D. Alternatively, the switch 14 can be designed with more than four or fewer than four interfaces 30.

In FIG. 1, the interfaces 30 can be referred to as the A interface 44, the B interface 46, the C interface 48, and the D interface 50. In this embodiment, (i) the A interface 44 is part of the A port group 34A, and is directly electrically connected to and services ports 0-3; (ii) the B interface 46 is part of the B port group 34B, and is directly electrically connected to and services ports 4-7; (iii) the C interface 48 is part of the C port group 34C, and is directly electrically connected to and services ports 8-11; and (iv) the D interface 50 is part of the D port group 34D, and is directly electrically connected to and services ports 12-15. In one embodiment, each of the interfaces 44-50 includes logic that controls the transfer of data between the ports 28.

The number of connectors 32 used in the switch 14 can be varied according to the number of interfaces 30. In FIG. 1, the switch 14 includes ten connectors 32 that can be named an AB connector 52, an AC connector 54, an AD connector 56, a BC connector 58, a BD connector 60, a CD connector 62, an AA connector 61A, a BB connector 61B, a CC connector 61C, and a DD connector 61D. In this embodiment, (i) the AB connector 52 directly connects the A interface 44 to the B interface 46; (ii) the AC connector 54 directly connects the A interface 44 to the C interface 48; (iii) the AD connector 56 directly connects the A interface 44 to the D interface 50; (iv) the BC connector 58 directly connects the B interface 46 to the C interface 48; (v) the BD connector 60 directly connects the B interface 46 to the D interface 50; (vi) the CD connector 62 directly connects the C interface 48 to the D interface 50, (vii) the AA connector 61A loops back and directly connects the A interface 44 to the A interface 44, (viii) the BB connector 61B loops back and directly connects the B interface 46 to the B interface 46, (ix) the CC connector 61C loops back and directly connects the C interface 48 to the C interface 48, and (x) the DD connector 61D loops back and directly connects the D interface 50 to the D interface 50.

In one embodiment, the connectors 32 between interfaces 30 have enough bandwidth to support the aggregate bandwidth of the ports 28 in the port group 34. For example, the bandwidth of the connectors 32 can be time-sliced so that that all ports 28 in each port group 34 have a dedicated portion of the connector 32 bandwidth, each portion of which is large enough to support the maximum bandwidth that the port 28 can provide. In this way, the parallel data transfer advantage in bandwidth that is achieved in the traditional mesh architecture is maintained while the number of connectors 32 required can be reduced to make this hybrid architecture more size-efficient.

As one non-exclusive example, each interface 30 can have a bandwidth of approximately 10 gigabits/second. In this example, if all of the ports 28 of a particular interface 30 have data to transmit, each of the ports 28 would get 2.5 gigabits/second for a 10 gigabit/second system. Alternatively, (i) if only three ports 28 have data to transmit, each of the ports 28 would get 3.3 gigabits/second for a 10 gigabit/second system, (ii) if only two ports 28 have data to transmit, each of the ports 28 would get 5 gigabits/second for a 10 gigabit/second system, or (iii) if only one port 28 has data to transmit, this port 28 would get 10 gigabits/second for a 10 gigabit/second system.

Additionally, the switch 14 includes a switch control system 63 that controls the transfer of each data packet in the switch 14. In one embodiment, the switch control system 63 is uniquely designed to allow for the dynamic updating of the destination vector 215 (illustrated in FIG. 2A) during the transmission of the data packet.

In one embodiment, the switch control system 63 is a distributed, decentralized control system with each port 28 including a separate port control system 63A. In this embodiment, each port control system 63A can independently make decisions regarding its port, in parallel with the other port control systems 63A. Additionally, each of the interfaces 30 can also includes an interface control system 63B that controls the flow of data to and from that interface 30. In this example, each of the control systems 63A, 63B is merely a place where control and logic can occur.

Alternatively, for example, the control of data can occur in just the ports 28 with the separate port control systems 63A, or just the interfaces 30 with the interface control systems 63B.

Still alternatively, the switch control system 63 can include a single, centralized control system that controls the operation of the switch 14.

In one embodiment, the control system 63 uses a switching algorithm that provides high performance bandwidth for the switch 14 while ensuring that all of the ports 28 are fairly serviced. In certain embodiments, this switching algorithm ensures packet-order compliance while minimizing the impact on performance on the switch 14.

In one embodiment, the control system 63 use a switching algorithm in which all data packets stored in the buffer 28B of each port 28 of a given priority are read out sequentially without waiting to see if a particular packet is accepted or rejected at the intended destination port. Stated in another fashion, each data packet in the buffer 28B of the port 28, per priority, is sent sequentially without waiting for acknowledgements or aborts. In this embodiment, the data packets in each port 28 are read out sequentially with the highest priority data packets granted transmission before the lower priority data packets. For example, data packets with priority 1 in the port will be transmitted before data packets with priority 0 in the port. In this example, if the port only has two data packets with priority 1 and three data packets with priority 0, the two priority 1 data packets will be sequentially sent and then the three priority 0 data packets will be sequentially sent without waiting to see if a particular packet is accepted or rejected at the intended destination port.

In this design, the acceptance or rejection of a particular data packet is determined later when the source port receives either an acknowledgment or abort signal from the intended destination port for each packet that had been read out. This architecture is a simple, space-efficient solution to head-of-line blocking for packets within the input buffer of a particular priority. This type of packet reading can provide a significant performance increase in randomized traffic as it allows packets to be transmitted when otherwise those packets could be blocked by a packet at the front of the queue that is waiting for a congestion at its intended destination port to be resolved.

In one embodiment, each of the port control systems 63A can access a destination register 64A (illustrated as a box), and a response register 64B (illustrated as a box) in the packet tracker 28C. The destination register 64A and the response register 64B are described in more detail below.

FIG. 2A is a simplified illustration of how a data packet 264 (illustrated with dashed lines) can be transferred from one source port to a destination port. In this embodiment, the data packet 264 is transferred from port 0 to ports 8 and 11. For clarity, only ports 0-3 and 8-11, the A interface 44, the AC connector 54, the C interface 48 are illustrated in FIG. 2A. In this example, the data packet 264 starts at port 0, and is sequentially transferred to the A interface 44, the AC connector 54, the C interface 48, and ports 8 and 11.

The port at which the data packet 264 starts (port 0 in the previous example) can be referred to as the “source port”, while the port(s) in which the data packet 64 is/are directed (ports 8 and 11 in the previous example) each can be referred to as a “destination port”.

FIG. 2A also illustrates that a response 266 is sent from ports 8 and 11 to port 0. The response 266 can be in the form of an acknowledgement if the data packet 264 is successfully transferred to the respective destination port, or an abort if the data packet 264 was not successfully transferred to the respective destination port. An abort can occur if the destination port has no ability to receive the data packet 264 due to its output buffer being filled, or some other reason.

Additionally, an abort can also occur if the source port has insufficient memory available to track the packet. In this case, the source port has insufficient resources available to send the packet and no packet is sent to the destination ports.

In this example, the data packet 264 includes an original destination vector 215 having the original destination address 268 of port 8 and the original destination address 268 of port 11. The term “destination address” is sometimes referred to herein as “destination”.

In certain embodiments, the present invention allows for the original destination vector 215 to be updated to add destinations or remove destinations while the data packet 264 is in the switch 14 prior to the receipt of all of the acknowledgements. Alternatively, in another embodiment, the original destination vector 215 can only be updated prior to the receipt of all of the responses 266 (either an acknowledgement or an abort.)

FIG. 2B is a simple illustration of an updated destination vector 215B. In this example, with the data packet in the switch and prior to the receipt of all of the acknowledgements, destinations 268B (ports 9 and 10) have been added to the original destination vector 215 (illustrated in FIG. 2A). With this design, the data packet 264 is now also transferred to the newly added destinations.

FIG. 2C is a simple illustration of an updated destination vector 215C. In this example, with the data packet in the switch and prior to the receipt of all of the acknowledgements, destination (port 11) has been removed from the original destination vector 215 (illustrated in FIG. 2A).

In this embodiment, if the data packet had not already been sent to the removed destinations (e.g. port 11 in this example) prior the updating of the original destination vector 215, the data packet 264 is not sent to the removed destinations (e.g. port 11 in this example). Alternatively, if the data packet had already been sent to the removed destinations (e.g. port 11 in this example) prior to the updating of the original destination vector 215, the present system can send a message to the removed destination (e.g. port 11 in this example) that the data packet should be removed. For example, the switch could send a discard packet to the removed destination (e.g. port 11 in this example) instructing the removed destination and/or components downstream of the removed destination to remove that data packet.

FIG. 3 is a simplified illustration of another embodiment of a integrated circuit 310; and a switch 314 that includes a switch control system 363, only four ports 328 (ports 0-3), and parallel electrical connectors 332 from every port 328 to every other port 328 in the switch 314. This type of architecture can have very high bandwidth because of the amount of data that can be flowing through the switch 314 in parallel.

It should be noted that the switch 314 illustrated in FIG. 3 does not include an interface 30 (illustrated in FIG. 1) like the switch 14 illustrated in FIG. 1.

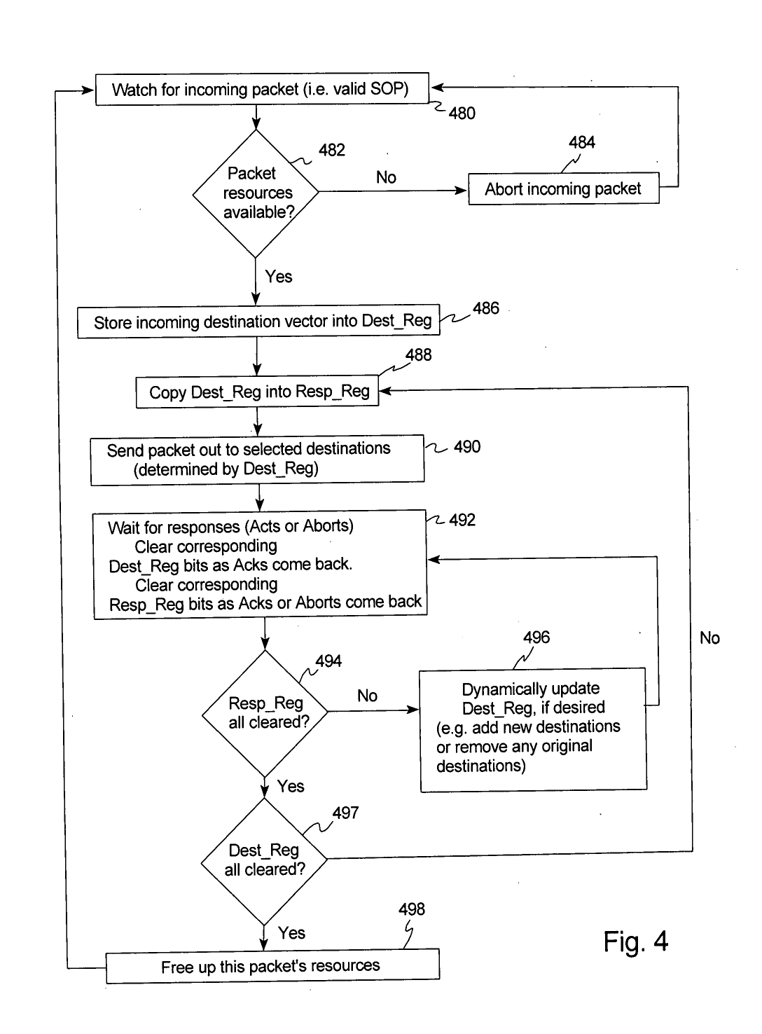

FIG. 4 is a flow chart that illustrates packet transfer flow used by the switch control system 63, 363 in the switch 14, 314. The switch control system 63, 363 allows for the dynamic updating of the original destination vector 215 (illustrated in FIG. 2) during the transmission of data. With this design, the packet is transmitted to the newly added destinations in addition to the original destination(s). This method applies to both a multicast packet, as well as a unicast packet, which effectively becomes a multicast packet. Alternatively, the original destination vector 215 can be updated to remove one or more original destinations.

Referring to FIG. 4, an incoming packet is observed, i.e. a valid Start-Of-Packet (SOP) 480. The data is received by the switch at the source port. If there are sufficient packet resources available 482 at the source port to store and transfer this packet (e.g. there's sufficient memory to store the data packet in the buffer, and sufficient memory to track the packet in the switch) then the packet is accepted and the destination vector is stored (along with other packet related information) 486. If there are insufficient packet resources available in the source port, the packet is aborted 484.

The destination vector is stored into the Destination Register (“Dest_Reg”) 486. Additionally, the Destination Register is copied into another register, called the Response Register (“Resp_Reg”) 488. At this time, the packet is sent out through the switch to all its respective original destinations, as determined by the contents of Dest_Reg 490.

After a set amount of time, i.e. the round trip delay of an Acknowledgement (“Ack”) or Abort through the switch, various packet Acks or Aborts come back for each respective sent destination 492. The Acks and Aborts come back asynchronously to each other, i.e. Acks will come back at the end of the transfer, whereas Aborts can happen at any time up to then. As each Ack comes back, the corresponding bit in both the Dest_Reg and Resp_Reg is cleared. As each Abort comes back, the corresponding bit in the Resp_Reg is cleared. It should be noted that since an Ack and an Abort are mutually exclusive for a given destination, the corresponding Resp_Reg bit will only be cleared once.

As each Ack or Abort response comes back, the Resp_Reg is checked to see if it is completely cleared, i.e. all attempted destinations have responded with either an Ack or Abort 494. If it is not ‘all clear’, then the system keeps waiting for more Acks or Aborts.

In one embodiment, the Dest_Reg can be dynamically updated with additional destinations or removed destinations 496 received from the source port during the time when the packet is initially received by the source port until the time the Resp_Reg becomes ‘all clear’. With this design, something external to the switch can decide to add or remove destinations from the original destination vector after the packet is received by the switch and during the transfer of the packet by the switch. In one non-exclusive example, a counter (not shown) can request that a data packet be sent to a specific destination port after a predetermined number of packets are received by the source port. With this design, the data packet can be sent to the switch without waiting for all possible destination changes, and the destination vector can be subsequently updated. Stated in another fashion, the ‘Dynamic Destination Updating’ allows additional destinations to be added to an already existing multicast packet, as well as making a unicast packet become a multicast packet, all done on-the-fly while the data packet is in the switch. This approach is both flexible and simple, and has minimal influence, if any, on the performance of the switch.

Further, destinations can be removed at this time. In one non-exclusive example, a counter (not shown) can request that a data packet be removed from the original destination vector if that data packet has been aborted a predetermined number of times (e.g. one million times).

Once the Resp_Reg is ‘all clear’, the Dest_Reg is also checked to see if it's ‘all clear’ 497. The Dest_Reg will not be “all clear” if it has been dynamically updated or if one or more of the destinations have aborted. If it is not, then its contents are copied over to the Resp_Reg and the packet transfer is resent in full to any Aborted destinations, as well as to any newly added destinations. If Dest_Reg is ‘all clear’, then all of the respective packet's resources are freed up 498, and the switch can accept a new packet in its place, if needed.

In certain embodiments, with the burst read algorithm used herein, the destination vector can be dynamically updated at any time after the data packets have first been sent out until all acknowledgements are received.

While the particular invention as herein shown and disclosed in detail are fully capable of obtaining the objectives and providing the advantages herein before stated, it is to be understood that they are merely illustrative of one or more embodiments and that no limitations are intended to the details of construction or design herein shown other than as described in the appended claims.

What is claimed is:

1. A switch that transfers a packet for an integrated circuit, the packet including a destination vector that includes one or more original destinations, the switch comprising:
a plurality of ports that are connected to the integrated circuit; and
a switch control system that is electrically connected to the ports and that receives the destination vector, the switch control system allowing the destination vector to be dynamically updated while the packet is in the switch.

2. The switch of claim 1 wherein the control system allows for an added destination to be added to the destination vector.

3. The switch of claim 1 wherein the control system allows for a plurality of added destinations to be added to the destination vector.

4. The switch of claim 1 wherein the control system allows for a removed destination to be removed from the destination vector.

5. The switch of claim 1 wherein the control system allows for an added destination to be added to the destination vector and a removed destination to be removed from the destination vector.

6. The switch of claim 1 wherein the control system allows the destination vector to be dynamically updated during the transmission of the packet to the one or more destinations.

7. The switch of claim 1 wherein the plurality of ports includes a first port, a second port, and a third port.

8. The switch of claim 1 wherein the switch control system includes a destination register that stores the destination vector and a response register in which the destination vector is copied.

9. A switch that transfers a packet for an integrated circuit, the packet including an original destination vector, the switch comprising:
a first port, a second port and a third port that are connected to the integrated circuit; and
a switch control system that is electrically connected to the ports and that is adapted to receive the original destination vector that includes an original destination address of the second port, the switch control system allowing the original destination vector to be amended to include an added destination address of the third port while the packet is in the switch.

10. The switch of claim 9 wherein the control system allows the original destination vector to be amended to remove the original destination address from the destination vector.

11. The switch of claim 9 wherein the control system allows the destination vector to be dynamically updated during the transmission of the packet to the original destination address.

12. The switch of claim 9 wherein the switch control system includes a destination register that stores the destination vector and a response register in which the destination vector is copied.

13. The switch of claim 12 wherein the switch control system allows the destination register to be updated that stores the destination vector and a response register in which the destination vector is copied.

14. A method for transferring a packet, the packet including a destination vector that includes one or more original destinations, the method comprising the steps of:
providing a plurality of ports;
electrically connecting a control system to the ports, the control system receiving the destination vector; and
updating the destination vector in the control system while the packet is in the switch.

15. The method of claim 14 wherein the step of updating the destination vector includes the step of adding a destination address to the destination vector.

16. The method of claim 14 wherein the step of updating the destination vector includes the step of removing a removed destination address from the destination vector.

17. The method of claim 14 wherein the step of updating the destination vector occurs during the transmission of the packet to the one or more original destinations.

18. The method of claim 14 wherein the switch control system includes a destination register that stores the destination vector and a response register in which the destination vector is copied.
